(19) United States
(12) Patent Application Publication
(10) Pub. No.: US 2014/0040184 A1
(43) Pub. Date: Feb. 6, 2014

(54) AUTOMATED RELATIONSHIP ADVICE

(71) Applicant: Anne Benissan, Irvine, CA (US)

(72) Inventor: Anne Benissan, Irvine, CA (US)

(21) Appl. No.: 13/564,668

(22) Filed: Aug. 1, 2012

(51) Int. Cl. G06F 17/30

(52) U.S. Cl. 707/609; 707/703; 707/769; 707/E17.005; 707/E17.007; 707/E17.014

(57) ABSTRACT

A computerized system provides automatic generation and sending of advice to a first predetermined individual to help that person's relationship with a second predetermined individual. The advice content is composed and tailored from pre-written text based on the answers to survey questions from those individuals. Also, a gift suggestion system provides gift recommendations to the first predetermined individual to give to the second predetermined individual. One or more distinct invited groups of friends, relatives, provide the recommendations.

### FIELD

This disclosure relates to systems and methods for automatically generating sequences of tailored messages, particularly messages dealing with information related to relationship advice and personalized gift recommendations.

### BACKGROUND

There are many systems known for attempting to make matches between individuals. The goal of many of these systems is dating. They attempt to match individuals into pairs that are likely to decide to form a lasting couple. Many systems use self-reporting survey results regarding the individuals' characteristics, likes, and dislikes. However, the benefits of these systems essentially end when a couple is formed. Creating a couple and maintaining a couple's relationship are not necessarily the same problems. Daily life is increasingly challenging for couples that plan to last; divorce rates confirm this trend. What is needed are automated systems to help keep couples happy and together on a long-term basis.

### SUMMARY

This disclosure addresses that need. Many embodiments that use these teachings are systems that assist one member of a paired relationship, the “main user”, to better please the other member. One way this assistance is provided is in the form of a sequence of tailored automated messages for the main user. The messages can suggest specific actions to be taken with respect to the other party. The content of the messages can be determined by answers to survey questions from either or both members of the pair. In addition, with some versions, each member can nominate a small group of third parties to help them with their relationship. This help can be related to recommendations for gifts to be given from the main user to the other party. The inclusion of helpful third parties can create a very personalized overall experience with the third parties' input adding to the tailored automated messages.

Couples can be helped to stay together by providing a stream of automatically generated advice for one member of a couple as to how to keep the second member committed to the relationship. In a romantic relationship, the goal of a system could be to enhance the second member's feeling of being loved.

A stream of advice content can be composed by a system by automatically selecting from pre-determined content, the selecting being done based on characteristics of the first member, characteristics of the second member and characteristics of the couple's environment. Personality aspects are not necessarily required.

The technology and methods described are applicable to advising men on retaining the commitment of their wives'; to women on pleasing their husbands; to helping unmarried couples; and to helping same sex couples. In fact, these teachings are also applicable to pairs of individuals other than those in intimate personal relationships. A mother and daughter might desire help in communicating or the pair might have a purely commercial relationship such as business partners.

Some embodiments can include specific gift suggestions from one or more groups of cooperating third parties via an interface that keeps each group's suggestions separate and not accessible by anyone other than members of the inputting group and the main user.

### BRIEF DESCRIPTION OF THE DRAWINGS

FIG. 1 is a schematic overview of the flow of information in producing a sequence of advice messages;

FIG. 2 is a schematic overview of the flow of information in providing gift suggestions;

FIG. 3 shows a module level diagram of the system of embodiment number one;

FIG. 4A shows a flowchart for the actions taken in operating the first embodiment system;

FIG. 4B shows a flowchart for accepting and processing key celebration dates;

FIG. 4C shows a flowchart for the actions taken to send messages concerning key celebration dates;

FIG. 5 is an example decision tree used by the system of the first embodiment for determining an index into an advice database from survey data;

FIG. 6 is a simplified system operation diagram of the first embodiment;

FIG. 7 is a module level diagram of the system of a second version of the first embodiment;

FIG. 8 shows a flowchart for a second embodiment.

### OVERVIEW

Using computer systems, one member of a couple can get automated, but very tailored, relationship advice. One way to implement this is via implementing one or more relationship theories. ‘Men are from Mars and Women are from Venus’, and the less well known, ‘Why Men Are Like Dogs & How We Can Love Them’ are examples of books with a specific view on how couples might communicate more effectively and what specific behaviors by one party or the other might improve the long term viability of a relationship.

Systems described in this disclosure can use these types of theories to set out questionnaire items and offer advice based on those theories and the answers to particular questions. Answers to some questions by one or the other party might cause other answers to be viewed under one specific theory or another specific theory. The theories might be based on the point of view of well known popular works, might be based on academic peer reviewed published works, or based upon an understanding of human nature by the implementer.

Initial surveys, possibly followed up with supplemental surveys, can include questions to classify a person or a relationship into one of several categories. They might be: how long have they been together; does one partner earn significantly more than the other; do they have more than two young children; travel patterns, etc. An initial categorization might cause one of many potential theories to be invoked and the automatically composed message sequence can then be primarily driven by that theory or the combination of several theories.

As described in the summary above, there can also be a gift recommendation subsystem. The suggestions can come from a small group of people nominated by the husband or alternatively by the wife. The overall goal of an embodiment can be to enhance communications, reduce occasions of specific annoyances, and build trust. Therefore, a gift recommendation subsystem is not just about spending money on big-ticket items for major occasions. For example, it can accommodate a recommendation from the wife's co-worker like: “She had a hard time at work today and might need to have some time to herself to cool down before she is available for you.”

The appropriately selected sequence of pre-created material with the survey decision tree can provide one member with understanding of what truly matters for the other member. Although more broadly applicable, in many of the examples the first party is a male partner and the second party is his female partner and the goal of the advice is to make her feel more loved by the male partner.

One way to look at the inputs the male partner receives is that they are composed based on the questionnaires and the underlying theory of those questionnaires. They are designed to make the woman's mindset and desires understandable to the male partner. He does not waste his energy in doing irrelevant things for her. It is a bit like giving him a detailed bullet point list of what he should bring home in both tangible items and in attitude and actions.

It is well understood that some individuals have different learning styles. One may learn better when material is presented visually. Another person might learn better if material is presented auditorily. Some people learn best in a classroom setting while others learn much more effectively by self-directed reading.

The present teaching recognizes that there are realms besides learning in which individuals have widely varying styles that are effective for them and applies that to relationship advice. A high level view is that advice is being presented to a first party with actions the first party can take with respect to a second party in order to increase the probability of the two parties relationship improving or at least maintaining.

### Emotional Receptive Style

One aspect of a stream of advice is the substantive content of the advice. This can depend upon what makes the wife feel loved. As with the case of learning styles, women can be said to have different emotional receptivity styles. Does getting a backrub, seeing her husband doing the dishes without being asked, getting a thoughtful small gift of jewelry, or seeing her husband getting along with her mother make her feel the most loved? It might be “sweet nothings” whispered over the phone or a new car in the driveway. Knowing something about the wife's emotional receptive style can help determine the substantive content (what he is being asked to do) of the advice provided to the husband.

### Advice Receptivity

Another important factor is the husband actually listening to a particular bit of advice and taking the advised action. This will depended not only on the substantive advice but also the way in which it is conveyed. Men have an “advice receptivity style”. Different men may take to heart or alternatively, ignore advice depending on how the advice is couched. Therefore, the husband's best mode of receptivity to advice should be capitalized upon. This is somewhat analogous to a sports coach that might encourage one athlete and berate another athlete for the same performance, depending on the coach's perception of the optimum way to deal with each player.

Some men may be more likely to act on advice if it is stated authoritatively and matter-of-factly. Others might respond to advice in the form of an experiment “just try this and lets see what happens”. Still others might respond to analogies and discussions of feelings.

With the forgoing, we have learned that effective advice is advice given in a style and tone likely to be complied with by the advisee (1^{st} party) and advice that, if followed, will reach the 2^{nd} party as meaningful. However, there is another factor to the advice stream content, the couple's day-to-day environment.

### Mutual Environment

The advice lives in the couple's environment. Do they both work? Does either work from home? Are the finances balanced or imbalanced—and in what direction? What are their travel patterns? Are there children—how many and what ages? These factors and others make up the environment in which the advice is to be carried out. In order to have maximum value the advice stream should take these “environmental” issues into account, and sometimes directly address one or more of them.

Information on personality, likes and dislikes in music, entertainment and other general preferences are not necessarily required in this approach.

The present teachings include a systematizing of the insights discussed above. A large number of predetermined content portions can reside in a database. Particular advice content can be retrieved periodically or episodically to compose a time-sequence of advice messages. The messages are made available to the husband.

The retrieval of advice content can depend upon the 1st party's advice receptivity style, the 2nd party's peak emotional receptivity mode and the couples' mutual interaction environment.

### DETAILED DESCRIPTION

### First Embodiment

### Overview

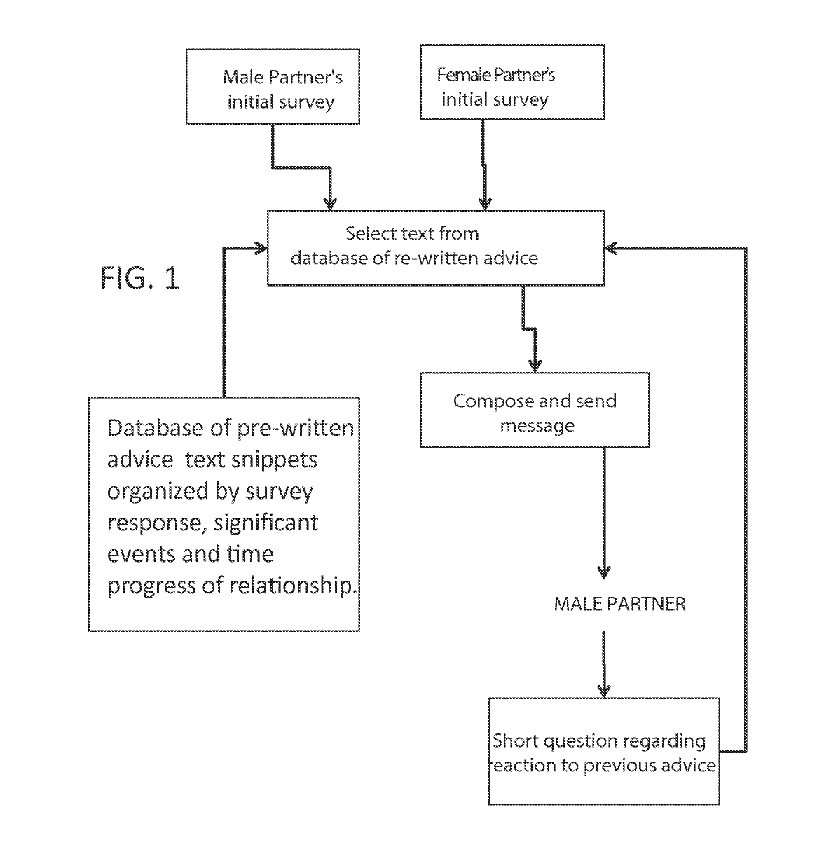

One specific embodiment is diagramed in FIGS. 1-6. In this embodiment, similar surveys are administered to each member of a couple via a web-based interface. For ease of explanation, the system is described as being applied to a heterosexual married couple with advice being provided to the husband. Survey questions for the wife can help determine the things that might bother her the most and please her the most. Survey questions for the husband might identify other important issues and the answers they each give to identical questions might be further enlightening. In this embodiment, there is an extensive database of pre-written snippets of text providing advice.

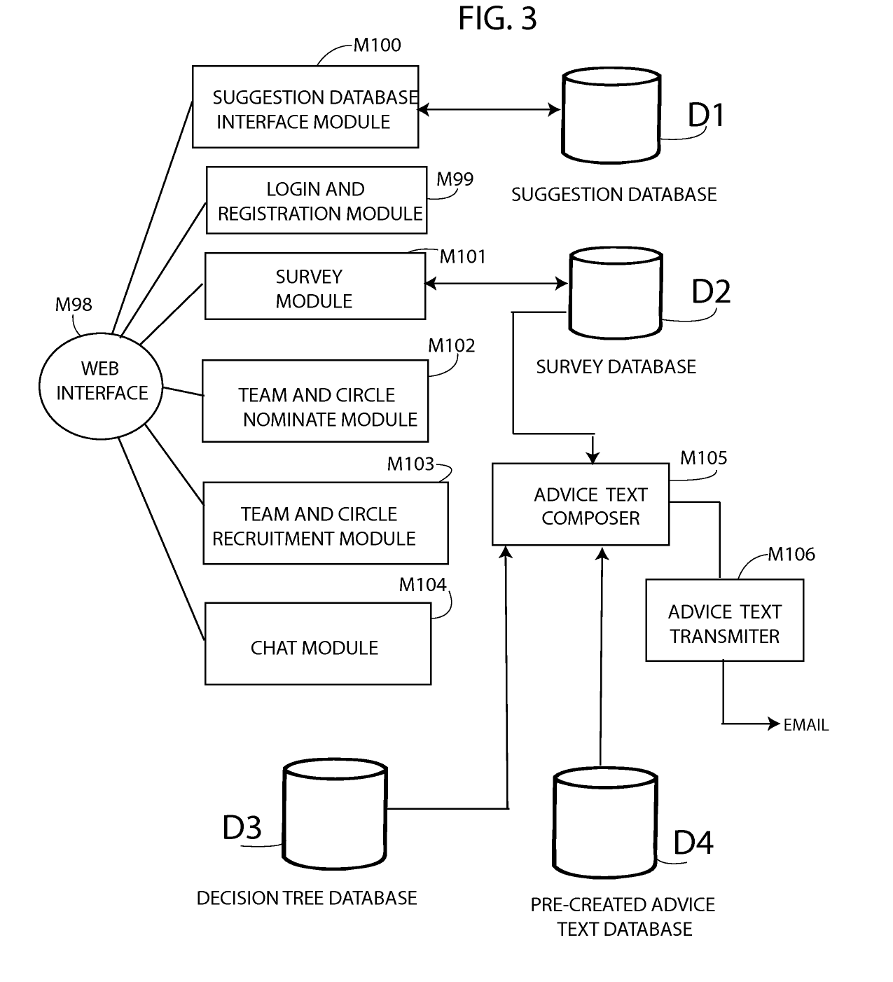

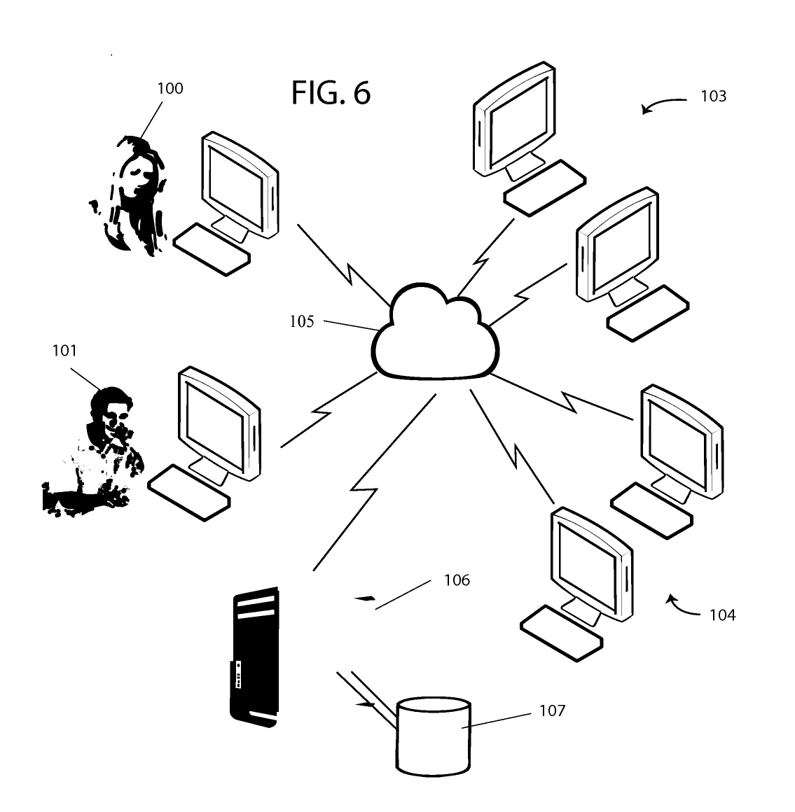

Answers to questions from both of the surveys drive the automatic selection of text snippets from that database to compose an initial advice message to the husband via a decision tree as shown in FIG. 3. A very simple view of the system in use is seen in FIG. 6. A woman 100 and her male significant other 101 are each accessing a server 106 over the Internet 105. The system uses a database 107. Helpers nominated by the woman 103 and those nominated by the man 104 can access the system in specific ways.

### First embodiment

### Structure

This embodiment is web based. Aspects of this include: the husband's initial signup page, his survey page, the wife's survey page, the husband's “team” nomination page, the wife's “circle” nomination page, the nominee information and sign-up page, a page to enter significant dates, and the husband's gift recommendation dashboard page. These are straightforward web interface forms and are not shown.

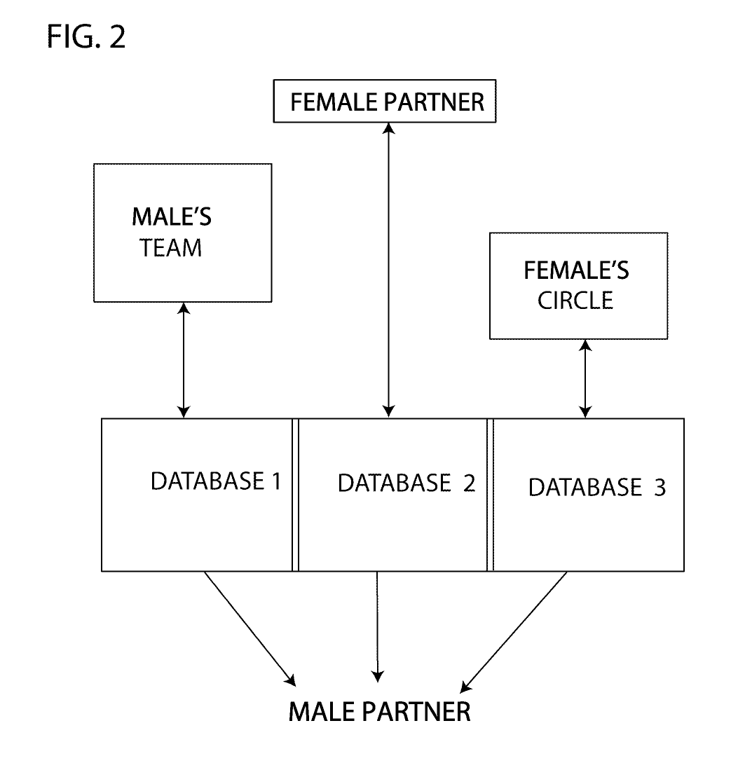

FIGS. 1 and 2 show simplified schematic information flows. In FIG. 1, the survey answers are used to automatically compose advice messages to the husband from pre-written advice text snippets. The advice varies as time progresses. This can be affected as significant dates come up and also based on feedback from the male partner to previous advice messages.

FIG. 2 shows information flow for the gift suggestion subsystem. The male partner's “team”, the female partner's “circle”, and the female partner herself each have separate database sections for their suggestions/wishes. This allows the male partner to view all of the suggestions and wishes but each of the three groups to only see their own inputs. The circle of female partner's friends and male partner's team are not limited to recommending material purchases for major events. This and other embodiments can provide for inputs like: “We'll take the kids for lunch on Saturday so you can have some time off” or “You should try that new lounge bar for a drink with her”.

FIG. 3 shows the several modules that comprise the first embodiment. A web interface module M98 provides for the users and the third parties to access the various front-end modules. One is the login and registration module M99. After registering, the main user and the other user can use the web interface module to access the survey module M101 to take their surveys and have the results stored in the survey database D2. The main user and his significant other can each use the web interface to access, respectively, the team and circle nominate module M102 to send emails to their nominees.

The team and circle nominees can use the web interface to access the team and circle recruitment module M103 to learn about the system and what is being asked of them. If willing to help the couple, a nominee can access the login and registration and module to join a respective group. At that time a nominee might decide to become a primary user and also register in that capacity.

After being recruited, a team or circle member can use the suggestion database module M100 to enter suggestions for the main user. The suggestions are stored in the suggestion database D1. Team and circle members can also access the chat module M104 to have other communication with the main user.

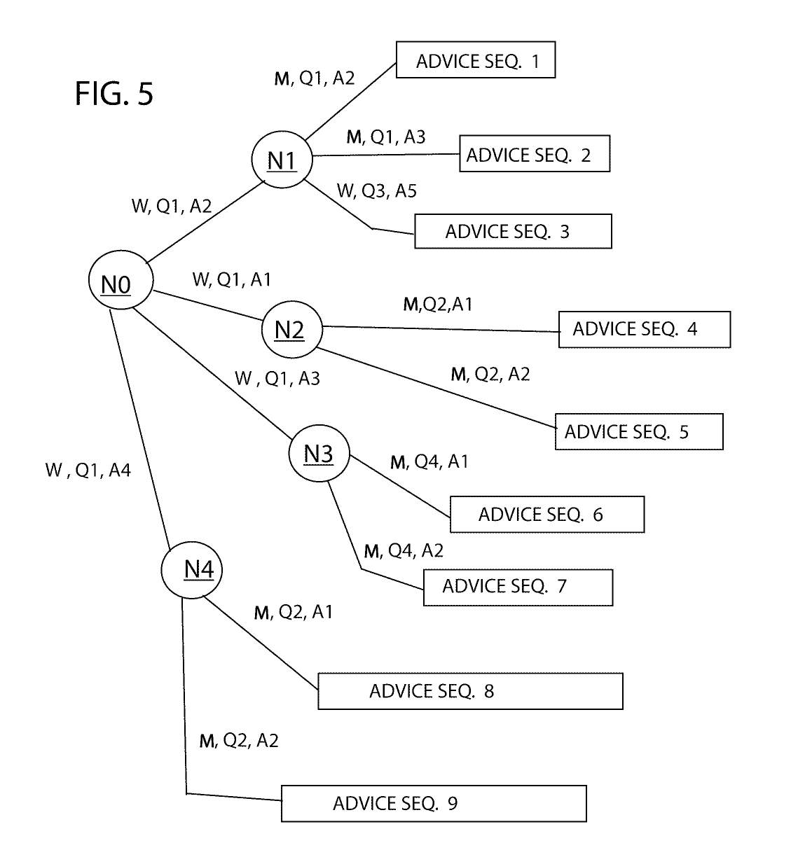

Within the back end of the system there are two pre-created databases. One is an advice text database D4. Another is a decision tree database D3. The advice text database contains labeled text snippets to be used in compositing periodic advice to the main user. This might be a relational database, a simple table, or other addressable structure. The decision tree stores the hierarchical rules by which the survey data is parsed and analyzed. An example decision tree is seen in FIG. 5.

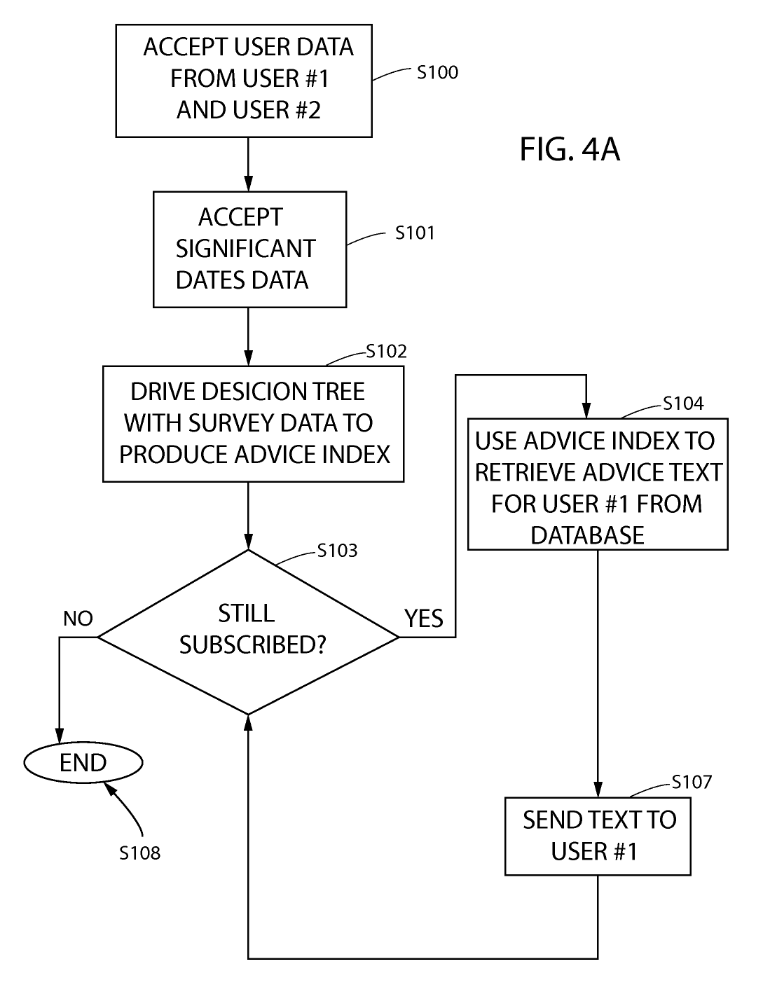

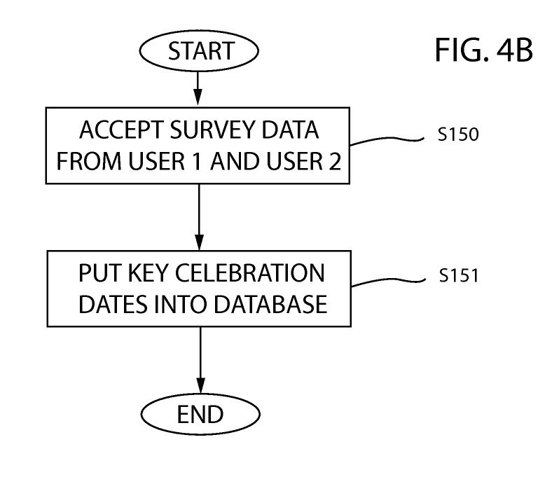

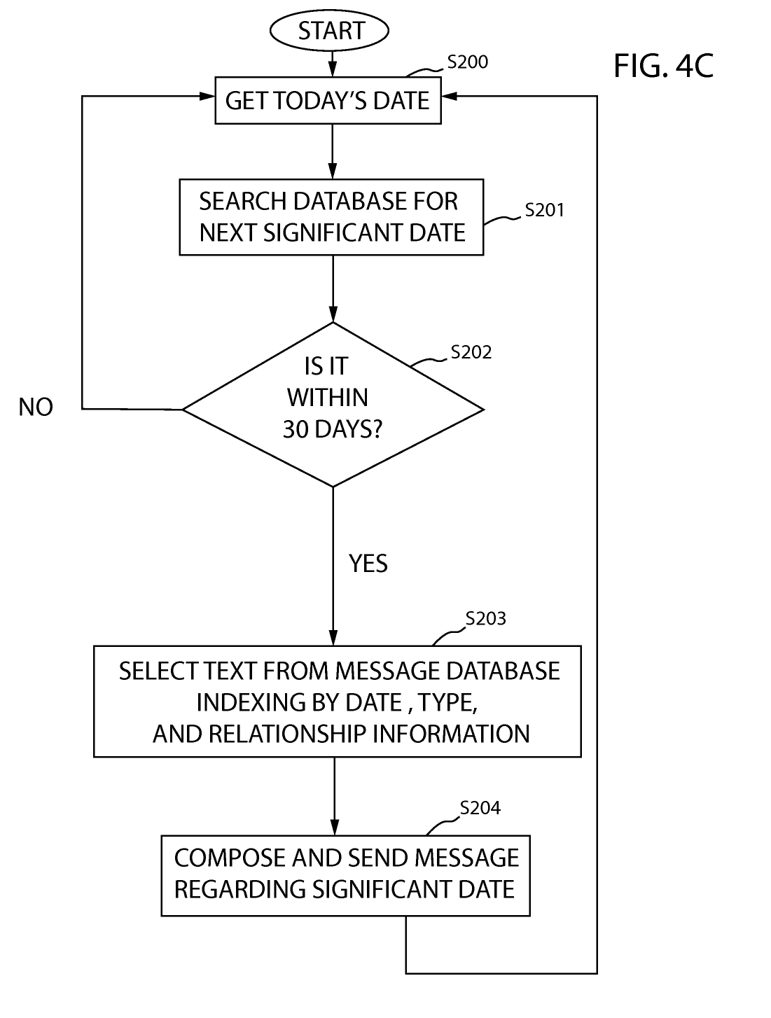

The modules of the back end shown in FIG. 3 are the advice text composer M105 and the advice text transmitter M106. The role of the advice composer is to drive the decision tree data with the survey database results to an end node that contains an index into the advice database D4. Based on the needs of the users and upcoming significant events, periodically or episodically the advice text transmitter module M106 sends a composite advice message to the main user. In this first version the messages are delivered by email. Each month or so a new message is automatically composed and sent. The subsequent messages are also determined by the initial survey but sequenced in an appropriate time ordering. One factor in the time ordering is the occurrence of important events as shown in the flow chart of FIG. 4A.

A web interface is also used for the husband and the wife to respectively solicit a small number of third parties to help them with the project of relationship enhancing. This is accomplished by email from the system to the nominees that direct them to web interfaces that explain the system to them. Those interfaces also allow the “helpers” to individually provide suggestions including gift suggestions.

The wife also has a view into the system via a specialized web interface. She can provide gift and desires “wish lists”. The only individual who can see the suggestions from all sourced is the husband. This allows the recommenders to be candid and helps to preserve some element of surprise to the wife.

### First Embodiment

### Operation

Initially, either the husband or wife can sign up for the service on a sign on page. The system can send a message to the other party explaining the system and its benefits and allowing the second party to sign up.

Then each party, separately, fills out a questionnaire. They can also nominate third parties to help them in their relationship-enhancing project. The wife might nominate a small number of her friends. The husband might nominate his mother-in-law, his wife's siblings, other men or other women who might have insight into his wife's tastes and moods.

Periodically, possibly once or twice a month, the system will automatically compose a message to the husband based on pre-written text snippets. The particular text chosen will depend upon the questionnaire answers, the occurrence of special dates, and the time progress of the relationship-enhancing project. These messages can be emailed or texted to the husband and can include a quick feedback question on the reaction to the previous week's advice.

The circle members, team members and the wife use interactive screens to post gift suggestions as occasions come up. The husband sees this information on his “dashboard” and can also chat or otherwise communicate with the circle members. He might ask if anyone knows her shoe size in a specific brand or if they remember seeing her wearing a particular item in the last year.

FIG. 4A is a flowchart that shows steps involved in the advice portion of the first embodiment. In step S100 the survey data from user #1 and user #2 is accepted. Another step provides for the acceptance of significant dates S101.

Once that information is accepted, a decision tree is traversed with the survey results S102. This step produces an index into a database of advice text. Over a period of time and in a repeated manner S103, the advice database index is used to retrieve pre-written advice text portions S104. This step takes into account the sequence order of the advice. Advice text is retrieved using the index and the number of the message. The text is sent to the main user S107. If the sequence of advice is completed the system is done S108.

FIG. 4B shows a flowchart for accepting and processing key celebration dates. For example, the couple could celebrate the first time they ever met. After the survey data is collected from both user #1 and user #2 S150, the system takes the key celebration dates obtained from those surveys and inputs them into the database S151.

FIG. 4C shows a flowchart for sending messages regarding key celebration dates. The program first obtains today's current date S200, after which a search of the database is conducted for the next upcoming significant date S201. In the next step, the system determines if the next significant date falls within 30 days S202. If “Yes” then a text is selected from the message database, indexed by date, type, and relationship information S203. The system then composes and sends the message regarding the significant date to users #1 S204. However, if the significant date does 290 not fall within the next 30 days the program automatically goes back to “get date” function S200.

FIG. 5 shows a simplified example of a decision tree. It is composed of intermediate nodes and terminal nodes. The decision tree starts with a first node N0. Triplets of information are indicated on branches from node to node. The form of the triplet is: which person's surveys, question number, answer number. For example, the branches from the first node are W, Q1, A2; W, Q1, A1; W, Q1, A3; and W, Q1, A4. They respectively lead to nodes N1, N2, N3, and N4. Following the decision tree eventual leads to a terminal node that ends the traversal and produces an index into an advice database.

### Options

Many variations on this first embodiment are possible. Of course the couple might or might not be married or be heterosexual. The survey might be taken on paper rather than on line. Advice messages might be multi-media including audio and video. Some men might be more likely to follow through with advice if it were 305 delivered in the form of an audio message from a sophisticated female voice. The third parties might include a “crowd sourcing” virtual circle of friends with data from the actual purchasing behavior of a large number of people fitting the demographic of the wife.

One specific approach to generating the advice messages is:
1. First, a male profile will be determined. This male profile will trigger the formation of a paragraph for the first email sent to the main user. In addition, it will also define the very first sentence of all subsequent emails reminders.
2. Second, personal information such as family situation, traveling frequency, whether she works or not will give the core of the first email to be sent as each option has a corresponding sentence.
3. Third, personal information regarding what the couple likes to celebrate will be gathered in order to determine the calendar and the date selection for each email. Main user should receive one to two emails per month.

A particular way to implement the third party suggestions and wish list is to:
1. First, at the end of her questionnaire female partner fills a wish list that she will be able to amend anytime in the future. This wish list is divided into several fields, each stating a type of wish. Types of wishes may include: small wish, current wish, favorite flowers, favorite spa/nail salon, favorite restaurants etc. Each wish is described briefly and a web link is provided for him to be able to access exactly what she wants.
2. Second, from her questionnaire, several names and emails of good friends will be gathered. An email invitation will be sent to them to register to become members of the circle. When these friends register, they have the possibility to open their own account and invite their male partner to join, or they can choose to only participate as the wife's helpers. They can add or change their input anytime after that. Whenever they know of something that would really please their friend, they can inform her partner in a brief but precise fashion with a web link that they can choose for his easy convenience.
3. Third, the main user has the possibility to invite anyone he thinks is relevant to be a member of his team. Relevance depends on the ability to bring valuable information on things that would please his female partner. It could be her mother, cousin, hairdresser, or anyone she might not have put on her circle list. The principles behind the circle's inputs are similar to those of suggestions from his team.
4. Fourth, below each section will be a message box allowing direct communication between each participant of the relevant section. The male partner will be able to ask questions and/or give feedback to circle and team members through that message box. Below her wish list there will be a rating system that the female partner will use to give him feedback.

### Decision Tree Message Creation

One manner to implement automatic but tailored advice messages is via a decision tree approach. Main user answers plus secondary user answers plus the sequence number can be combined to produce an index into a table with advice wording. In a very simplified example an answer indicating that the husband travels frequently might cause an index to a portion of an advice message like: “Dear [name], You seem to be traveling quite a lot. Make sure when you return from any trip you really pay attention to her, first thing, for 15 minutes.”

A decision tree can be represented by a directed graph. As seen in FIG. 5 there are a series of nodes, each leading to other nodes based on a triple of ordered information. The first field is M or W indicating whether the decision is based on the man's or the women's survey. The next value is the question number and the last is the selected multiple-choice answer. We see the initial branching is based on one specific question on the women's survey, in this example. Ultimately, the decision tree leads to an advice index value. More than one path might lead to the same index value. The index value is later used to retrieve the pre-created text from the advice text database.

Another way to look at the first embodiment is via its system block diagram. Shown in FIG. 3, there are several interconnected modules. One module provides for the users to take their surveys. Another module allows the two principals to nominate third parties to act as helpers. The nominated helpers have modules to explain the system to them and allow them to provide inputs.

The backend modules provide for using survey data to follow a decision tree and for the results of that tree traverse to lead to pre-created text to be retrieved and sent to the “main” user. When the periodic advice is transmitted to that user, it may be accompanied by a question. The question can be used to ascertain the success of the previous period's advice. Future advice selection can be automatically modified based on this feedback. If a significant data occurs in the period, additional relevant text can be merged with the next text message.

A third way to look at the first embodiment is from the point of view of the steps the system performs. The flowchart of FIG. 4A shows this view at a high level. The survey data is accepted as well as the significant date data. The survey data is used to traverse a decision tree to produce an advice index.

Periodically, the advice index is used to retrieve advice text from the database of pre-written advice. This database holds a time sequence of advice for each of the index values. For each successive period, the next bit of advice under the relevant index is retrieved. Next, the stored significant date information is accessed. If the period includes a significant date then additional pre-written information related to the occasion is sent as a separate message. The completed advice text is emailed to the main user. This is repeated for the course of the advice period and is automatically renewable.

With a survey of questions with several possible answers each, and surveys given to two people, a decision tree could have 1.6 times 10²¹ leaf nodes. That provides an enormous possible space for categorization of people, situations, and relationships. It may not be practical to consider each combination and pre-write a unique train of advice for each possible combination and permutation. This first embodiment might have a few hundred pre-written text portions. In order to add to this level of personalization a second aspect helping to inform and guide the man is provided. This second aspect is independent input from third parties.

### Third Party Inputs

As seen in the system diagrams of FIG. 2 and FIG. 6 there can be people involved in this process besides the couple themselves. The wife can nominate a small or a large group of her friends and peers to join a group, that for purposes of this document, will be called her “circle”. The husband can nominate a small or large group of people that he thinks might be helpful to become part of a group, that for purposes of this document, will be called his “team.” The wife, circle members, and team members each provide input by entering information into a supplemental database. The inputs can be gift suggestions/wish list items or can be more general advice suggestions and insights. As seen in FIG. 2 the data entered is placed in separate regions of a database. The male partner, (user #1) can see all of the entered information. The circle members and the team members can each, respectively, only see inputs from themselves and fellow members of their groups. The female partner's inputs are not visible to the third parties. This structure allows the male partner to get unbiased inputs as mentioned earlier. Each team member can choose a website from a series of pre-selected affiliated sites to accompany the suggestion.

### First Embodiment

### Variations

The sent text might be sent by SMS rather than email. There might be multiple decision trees, each based on one theory of interpersonal behavior. In some versions, multiple decision trees might be traversed leading to multiple pre-written texts. The composition process would then merge multiple text snippets to create each of the periodic advice messages. A version might special-case the significant dates and have messages only relating to significant dates sent separately and in addition to normal periodic messages.

### Affiliate Programs

An optional aspect of this system are affiliate networks of merchants and web sites that might carry the type of items likely to be recommended to be given by the first user to the second user. In the view of the gift recommendation system of the 2nd user, the circle and the team there can be selections for very specific products. In this case a team member my not just indicate, “I think she would like a leather purse” but also check off several actual products. Similarly, the first user's gift dashboard can allow that user to take generic suggestions from the team and circle and, within the dashboard, readily search for actual sources of specific products. The system operator can monetize these aspects of the system.

### First embodiment

### Second Version

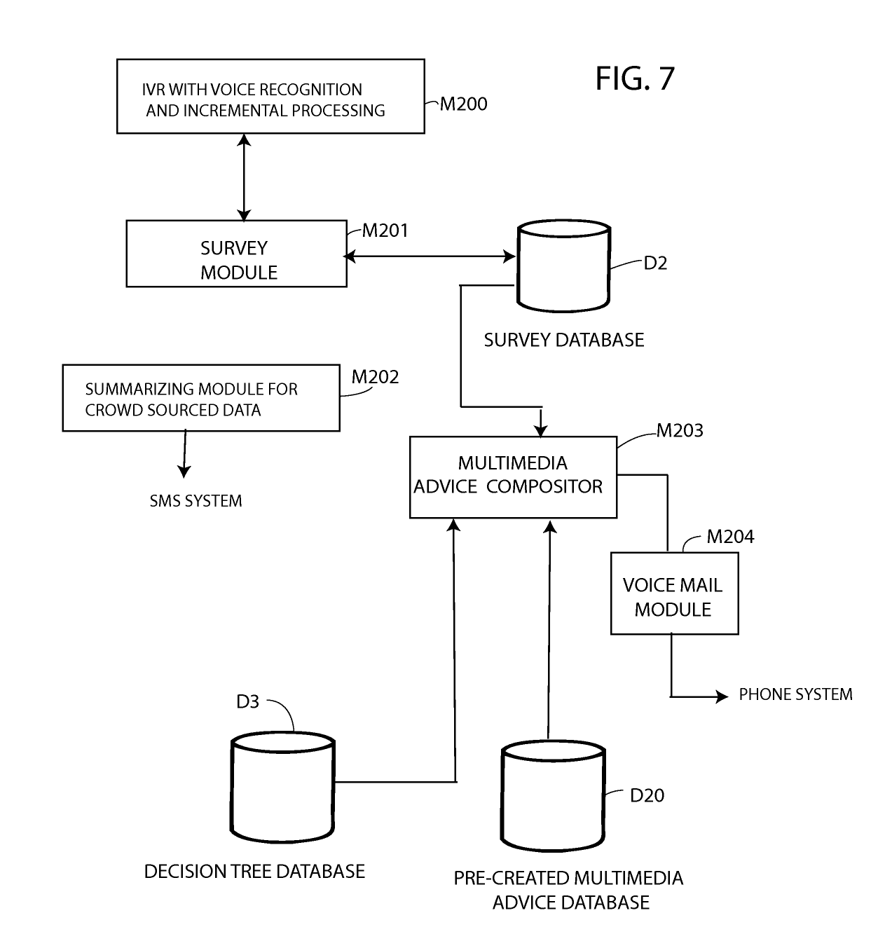

An alternate embodiment seen in FIG. 7 is audio based with an Integrated Voice Response (IVR) system for both the initial survey and for the periodic advice.

Voice recognition and IVR technology are used to present the surveys and to get the users' answers. To make it easier for the users, the survey can be answered in multiple short sessions incrementally working through the questions. The user can review and change his or her previous answers before finalizing the survey. This embodiment is shown in the flowchart of FIG. 7.

In this version, the advice is pre-recorded audio. It might be in a helpful, sensitive female voice in the case the advice is for a male in a relationship with a woman. The audio advice is sent to the man as a phone call that he might let go to voice mail. Third party input is provided to the main user by text that is automatically consolidated from data derived by the purchases and opinions of a large number of people fitting the woman's demographic and lifestyle profile. These “helpers” are unwitting helpers whose information is statically derived from Internet searching and social networking sites.

FIG. 7 shows the modules of the second embodiment. One module includes the capability to present survey questions to the users via an audio interface M200. In this step, the questions and multiple-choice answers are presented via a telephonic connection. A push button IVR interface can be used although a voice recognition system can be easier to use. Another ease of use feature can be the ability to partially complete the survey in a session and hang up. In cooperation with the main survey module M201, a subsequent call can be used to pick up where the user left off to complete more of the survey.

The survey module stores the survey results in a database D2. The backend modules include the multimedia advice compositor M203 and the voice mail module M204. The advice compositor can take inputs from the survey result and use them to drive the decision tree database D3. This module uses the information from traversing the decision tree to retrieve pre-created multimedia advice content from a database D20. That database can include a person reading the advice. After the multimedia advice is created, it can be sent to the main user's voice mail. As in the first embodiment, the third parties might include a “crowd sourcing” virtual circle of friends with data from the actual purchasing behavior of a large number of people fitting the demographic of the wife. One way of doing this is shown in module M202 that feeds an SMS system.

### Second Version

### Variation

In this embodiment, only the advice might be in an audio form, not the surveys. In addition, the audio might be delivered as an emailed mp3 file. In addition, the email could be multimedia with video and audio used to convey the advice. A vignette of a woman reacting positively to the suggested action might be included.

Of course, aspects of the first embodiment might be intermixed with aspects of the second embodiment. The second embodiment might have either or both of her circle and his team.

### Second Embodiment

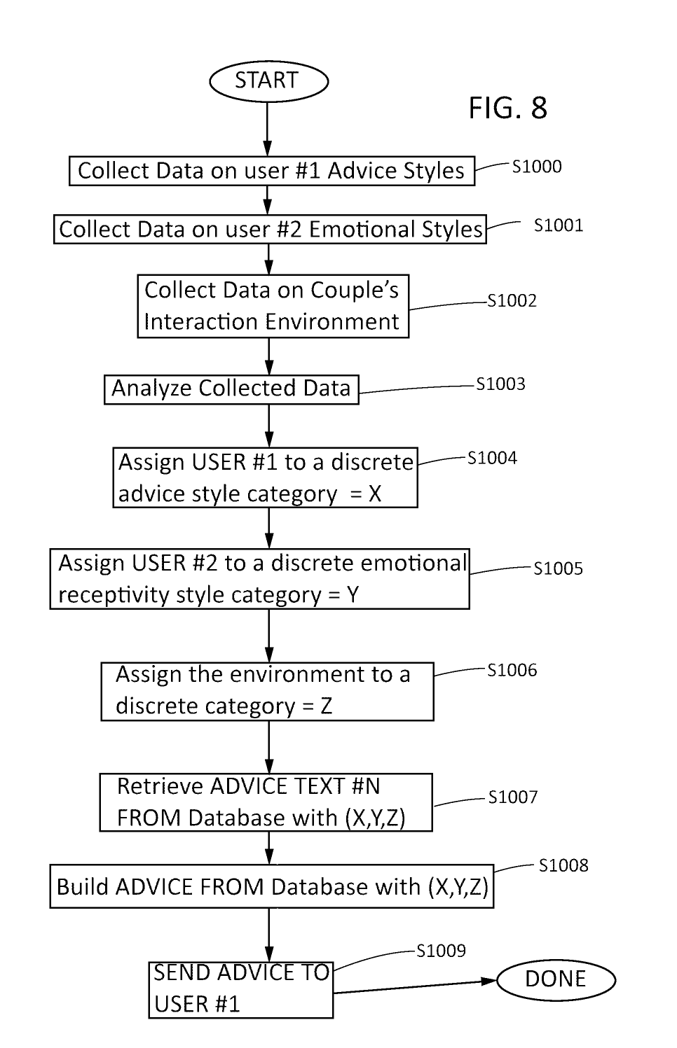

A second embodiment is based on questionnaires filled out online by each party. The advice originates from pre-created text paragraphs that are delivered electronically to a first party. FIG. 8 shows a global flow chart of the process.

In step S1000 data is collected regarding the first party's advice receptivity style. In step S1001 data is collected regarding the 2^{nd} party's emotional 490 receptiveness mode. Then in step S1002 data is collected and regarding the couple's interaction environment. Then it is analyzed S1003. Each of the three factors is assigned to a discrete category. These steps are S1004, S1005, and S1006, respectively for the emotional receptiveness, advice style and environment.

Using the triplet of the three discrete factors, a database of pre-created advice content is accessed and advice retrieved S1007. The retrieved data is used to compose S1008 an advice message that is sent S1009 to the first party.

Data collected regarding the 1^{st} users' advice receptivity style may be primarily derived from answers the 2^{nd} party gives on a survey. It might be based on both surveys or could be non-survey data. Similarly, the other two types of data collected may be acquired from surveys of one or both of the parties. Data may be collected by means other than surveying the pair.

Data analysis is done by a programmed computer and can include a cluster analysis, a weighted point system, linear regression, artificial neural net, decision tree or other method.

1-26. (canceled)

27. A method of generating a stream of advice by a computer system having a processor comprising:
receiving data from completed questionnaires by a first and by a second party of a pre-existing couple;
assigning the first party to one of a predetermined set of advice substance classifications based upon the questionnaire response data, there being a plurality of such discrete classifications;
assigning the second party to one of a predetermined set of advice tone classifications based upon the questionnaire response data, there being a plurality of such discrete classifications;
providing a database including a plurality of advice content sequences organized orthogonally by substance classification and tone classification;
retrieving, from the database, a time sequence of advice content for the second party with respect to the first party, database indexing based on the substance classification of the first party and the tone classification of the second party;
communicating portions of the retrieved time sequence of advice content to the second party on a generally periodic basis.

28. The method of claim 27 further comprising:
assigning the couple to one of a predetermined set of mutual environmental classifications based upon the questionnaire response data, there being a plurality of such discrete classifications; and where the provided database further includes, as a third dimension, advice content by environmental classification and the retrieving further includes indexing the assigned environmental classification.

29. The method of claim 27 where at least some content comprises text.

30. The method of claim 27 further comprising:
composing messages comprising portions of the retrieved time sequence of content merged with supplementary content regarding gift suggestions.

31. The method of claim 27 where the portions of advice content are transmitted periodically at a period between about once per week to once per month.

32. A system for generating a sequence of advice using a computer system with a processor configured for:
receiving data from completed questionnaires by a first and by a second party of a pre-existing couple;
assigning the first party to one of a predetermined set of advice substance classifications based upon the questionnaire response data, there being a plurality of such discrete classifications;
assigning the second party to one of a predetermined set of advice tone classifications based upon the questionnaire response data, there being a plurality of such discrete classifications;
providing a database including a plurality of advice content sequences organized orthogonally by substance classification and tone classification;
retrieving, from the database, a time sequence of advice content for the second party with respect to the first party, database indexing based on the substance classification of the first party and the tone classification of the second party;
communicating portions of the retrieved time sequence of advice content to the second party on a generally periodic basis.

33. The system of claim 32 where the system is further configured to perform the additional actions of:
assigning the couple to one of a predetermined set of mutual environmental classifications based upon the questionnaire response data, there being a plurality of such discrete classifications; and where the provided database further includes, as a third dimension, advice content by environmental classification and the retrieving further includes indexing the assigned environmental classification.

34. The system of claim 32 where the system is further configured to perform the additional actions of:
composing messages comprising portions of the retrieved time sequence of content.

35. The system of claim 32 where the system is further configured to perform the additional actions of:
composing messages comprising portions of the retrieved time sequence of content merged with supplementary content regarding gift suggestions.

36. A method of providing semi-tailored advice for a first party to consider acting upon in relation to a second, target party using a computer system with a processor comprising:
providing a database of advice content that is organized in three dimensions, a first dimension being situation cases, a second being classes of first party receptivity to advice, and a third varying by classes of target party's receptivity to actions by the first party;
automatically characterizing the situation, the target party's receptivity to actions, and the first party's receptiveness to advice; the characterizing determined from questionnaire data;
selecting an item of advice content from the database to provide to the first party, the selecting corresponding to the characterizations.

37. The method of claim 36 where at least a portion of the database is organized into four dimensions, the records in the fourth dimension varying by time sequence and the selecting further based on a sequence number.
